(19) United States
(12) Patent Application Publication
(10) Pub. No.: US 2022/0141180 A1
(43) Pub. Date: May 5, 2022

(54) METHOD FOR PROCESSING VIA CONDITIONAL AUTHORIZATION

(71) Applicant: Visa International Service Association, San Francisco, CA (US)

(72) Inventors: Gurpreet Singh Bhasin, Fremont, CA (US); Prashant Desale, Foster City, CA (US); Biju Abraham, Fremont, CA (US); Rajiv Dutta, Palo Alto, CA (US)

(21) Appl. No.: 17/413,924

(22) PCT Filed: Dec. 19, 2019
(86) PCT No.: PCT/US2019/067396

§ 371 Date: Jun. 14, 2021

Related U.S. Application Data
(60) Provisional application No. 62/784,272, filed on Dec. 21, 2018.

(51) Int. Cl. H04L 9/40; G06Q 20/40

(52) U.S. Cl. CPC H04L 63/0209; G06Q 20/401; H04L 63/108

(57) ABSTRACT

A system and method for transaction processing with conditional authorization are disclosed. The method includes receiving an authorization request message from a resource provider and sending the authorization request message to an authorizing entity. When an error response is received from the authorizing entity, the method includes determining a conditional authorization response and sending the conditional authorization response to the resource provider. Then a final authorization response is sent to the resource provider.

### CROSS-REFERENCE TO RELATED APPLICATIONS

This application is a PCT application claiming priority to U.S. Provisional Application No. 62/784,272, filed on Dec. 21, 2018, which is herein incorporated by reference in its entirety.

### BACKGROUND

Currently, when completing a transaction, a resource provider must wait until receiving an authorization from an authorizing entity in order to complete an interaction. There may be situations where the authorization cannot be completed at the time of the transaction. For example, there may be technical problems preventing the resource provider from sending an authorization request, or preventing the resource provider from receiving the authorization response. Without an authorization, the resource provider may need to cancel the interaction, or may need to resubmit the authorization request. The latter can result in the use of additional computing resources while the former can result in the user not being able to obtain the desired resource.

Thus, there is a need to process authorization requests in a timely manner when the traditional authorization processes are not available.

Embodiments of the invention address these and other problems, individually and collectively.

### BRIEF SUMMARY

One embodiment of the invention includes a method comprising: receiving an authorization request from a resource provider; sending the authorization request to an authorizing entity; receiving an error response from the authorizing entity; determining a conditional authorization response; sending the conditional authorization response to the resource provider; and sending a final authorization response to the resource provider.

Another embodiment of the invention includes a gateway computer comprising: a processor; and a non-transitory computer readable medium, coupled to the processor, for executing the above method.

Another embodiment of the invention includes a method comprising: sending, by a resource provider computer, an authorization request message to a gateway computer, wherein the gateway computer sends the authorization request message to an authorizing entity, receives an error response from the authorizing entity, and determines a conditional authorization response message; receiving, by the resource provider computer, the conditional authorization response message from the gateway computer; and receiving, by the resource provider computer, a final authorization response message from the gateway computer.

Another embodiment of the invention includes a resource provider computer comprising: a processor; and a non-transitory computer readable medium, coupled to the processor, for executing the above method.

### BRIEF DESCRIPTION OF THE DRAWINGS

FIG. 1 shows a block diagram of system according to embodiments of the invention, along with an overlaid process flow.

FIG. 2 shows a block diagram of a gateway computer according to an embodiment of the invention.

FIG. 3 shows a block diagram of a transaction database according to an embodiment of the invention.

### DETAILED DESCRIPTION

Prior to discussing embodiments of the invention, some terms can be described in further detail.

A “user” may be an individual or a device. In some instances, a user may be a consumer who acquires a good or service. In some embodiments, a user may be associated with one or more personal accounts and/or mobile devices. The user may also be referred to as a cardholder, account holder, or user in some embodiments.

A “user device” may be any suitable device that is operated by a user. Suitable user devices can be portable, and can communicate with external entities such as access devices. Examples of user devices include cards that data stored on them, mobile phones, laptop computers, transponders, wearable devices such as smart watches, automobiles with remote communication capabilities, access cards, smart media, etc. A payment device may be an example of a user device.

A “payment device” may refer to a device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. If the payment device is in the form of a debit, credit, or smartcard, the payment device may also optionally have features such as magnetic stripes. Such devices can operate in either a contact or contactless mode.

An “acquirer” may be a financial institution associated with a merchant. Acquirers typically provide merchants with a bank account, and in some cases, transaction accepting infrastructure. Generally, after a transaction has been authorized and as part of the settlement process, funds are transferred from the issuer to merchant's account at the acquirer. The acquirer may also communicate payment transaction status with the merchant. The acquirer may operate an acquirer computer, which may generically be a transport computer.

An “authorizing entity” may be an entity that authorizes a request, typically using an authorizing computer to do so. An authorizing entity may be an issuer, a payment processing network, a governmental agency, an access administrator, etc. An authorizing entity may operate an authorizing entity computer.

An “issuer” may be a financial institution, such as a bank, that creates and maintains financial accounts for account holders. An issuer or issuing bank may issue and maintain financial accounts for consumers. The issuer of a particular consumer account may determine whether or not to approve or deny specific transactions. An issuer may authenticate a consumer and release funds to an acquirer if transactions are approved (e.g., a consumer's account has sufficient available balance and meets other criteria for authorization or authentication).

A “payment processing network” may be a network that can be used to process transactions. In some embodiments, a payment processing network may comprise data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. Authorization, settlement, and clearing may be done at the same time (substantially simultaneously, e.g., within a few minutes or hours) or may be done as part of a batch settlement process (e.g., at the end of the day or week).

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated fuel dispensers (AFDs), automated teller machines (ATMs), virtual cash registers (VCRs), kiosks, security systems, access systems, Websites, and the like. An access device may use any suitable contact or contactless mode of operation to send or receive data from, or associated with, a mobile device. The access device may be or be coupled to a resource provider computer.

An “authorization request message” or “authorization request” may be a message that is sent to request authorization for a transaction. An authorization request message may be sent, for example to a payment processing network, an issuer of a payment card, a payment processor, a cryptocurrency network, and/or an automated clearing house. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, for example, a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” or “authorization response” may be a message reply to an authorization request message. The authorization response message may be generated, for example, by an issuing financial institution, a payment processing network, a cryptocurrency network, a payment processor, and/or an automated clearing house. The authorization response message may include, for example, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant. An authorization response message may include a conditional authorization response message and final authorization response message.

A “conditional authorization response” message may be a message that indicates conditional approval for an interaction, and can be sent in response to receiving an authorization request message (e.g., from a resource provider computer). A conditional authorization response message may indicate preliminary approval of an interaction, but is subject to a decision in a final authorization response message. In some embodiments, a conditional authorization response message may be considered a placeholder for a final authorization response message, and may be generated in response to the receipt of an error response from an authorizing entity computer. In some embodiments, a conditional authorization response message may include all of the elements of a final authorization response message (e.g., a transaction value, a merchant identifier, a timestamp, the payment method, an approval indicator, etc.).

A “final authorization response message” can be a message that indicates final approval of an interaction (e.g., a transaction) by an authorizing entity or authorizing entity computer. A final authorization response message with an approval indicator from an authorizing entity may bind that authorizing entity to the interaction.

A “server computer” is typically a powerful computer or cluster of computers. For example, the server computer can be a large mainframe, a minicomputer cluster, or a group of servers functioning as a unit. In one example, the server computer may be a database server coupled to a Web server.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “resource provider” can be any suitable entity that provides resources (e.g., goods, services, access to secure data, access to locations, or the like) during a transaction. For example, a resource providing entity can be a merchant, a venue operator, a building owner, a governmental entity, etc. A “merchant” may typically be an entity that engages in transactions and can sell goods or services, or provide access to goods or services.

An “error response” may be a message reply to an authorization request message indicating the authorization process could not be completed. In some embodiments, an error response may be generated after a threshold time has elapsed, and after an authorization request message is sent and a final authorization response message has not been received from an authorizing entity computer. An error response may include transaction identifying information (e.g., a transaction amount, a timestamp, etc.), as well as information as to why the authorization request could not be completed (e.g., a server is down for maintenance, no response has been received from the authorizing entity computer).

An error response can be generated based upon a number of reasons. For example, an error response can be generated in response to a loss of communication between an acquirer and an issuer (e.g., a server failure or a discrepancy in network connection). In another example, an error response can be generated in response to a delay in receiving an authorization response message. In yet another example, an error response may be generated in response to receiving unexpected data in an authorization response message. For instance, an error response may include gibberish where it would be expected that the error response has an authorization code.

Embodiments of the invention may include generating a conditional authorization for a transaction. Typically, when completing a transaction, a resource provider computer waits until an authorization response message requesting approval for a transaction is received from an authorizing entity computer before completing the transaction. If the submission of the authorization request message to an authorizing entity computer results in an error response instead of a final authorization response message, then resubmission of the authorization request message by the resource provider computer may be needed. The conditional authorization processes according to embodiments of the invention can allow a transaction to proceed in an unimpeded manner, even when an error response is received.

In a conventional e-commerce transaction, there is a window of time between when a resource provider receives a (non-conditional) authorization response message for a transaction, and when the resource provider grants access to a resource (e.g., ships a product that was purchased). The time window may vary per resource provider, but can range from a few hours to a few days. After a resource provider grants access to the resource (e.g., ships the product), they may send a request to a gateway computer for the previously authorized funds for the transaction.

The conditional authorization processes according to embodiments can allow the resource providers' back-end processes continue to proceed during the time window. Before resource distribution (e.g., shipping), the resource provider can be notified whether the conditional authorization successfully transitioned to a final authorization, or was ultimately declined by the authorizing entity computer. If the final authorization response from the authorizing entity computer was approved, then the transaction proceeded in an uninterrupted manner for the user, thus saving the time, expense, and computational power needed to re-submit an authorization request message. If the final authorization response from the authorizing entity computer was declined, then the user conducting the transaction can be notified of the decline and the resource will not be shipped to the user conducting the transaction.

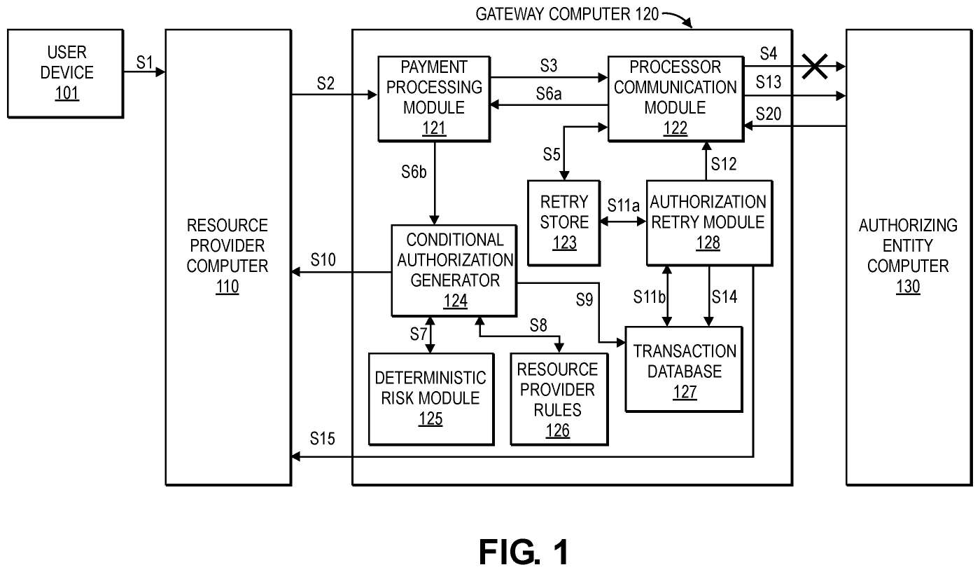

FIG. 1 shows a system for conditional authorization, wherein the system comprises a user device 101 operated by a user, that wishes to interact with a resource provider computer 110. The resource provider computer 110 may be in communication with a gateway computer 120, and an authorizing entity computer 130.

The user device 101 may be any suitable device that may be operated by a user to interact with another machine or device. For example, the user device 101 may be mobile phone or a laptop computer.

The resource provider computer 110 may be operated by a resource provider in order to process a transaction for providing goods and/or services to a user 101. The resource provider computer 110 may be a server computer such as a Web server computer, or it could alternately be a terminal such as a POS terminal or an gate terminal that allows access to a secure location. The resource provider computer 110 may be a server computer comprising a processor and a computer readable medium coupled to the processor. The computer readable medium may comprise code, executable by the processor to implement any of the functions described herein by the resource provider computer 110.

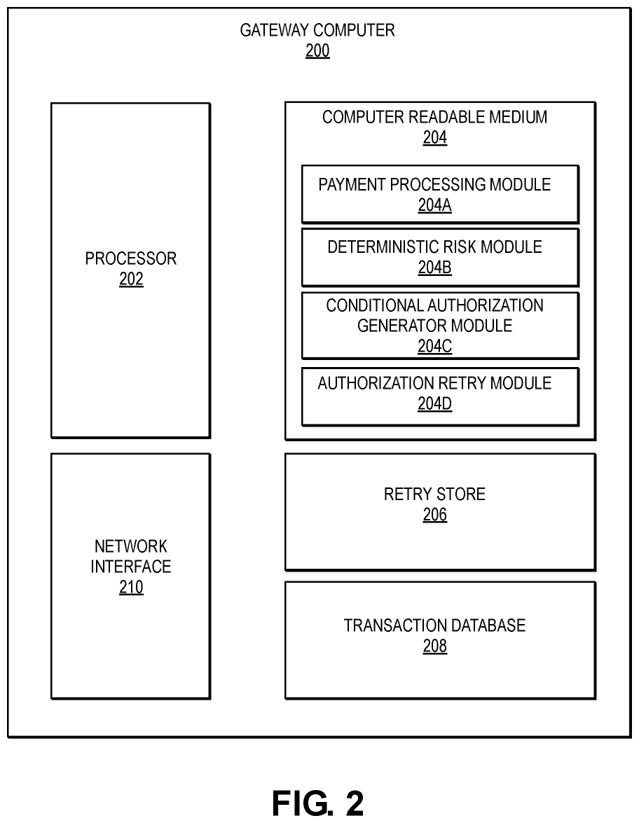

The gateway computer 120 may comprise a number of components including a payment processing module 121, a processor communication module 122, a retry store 123, a conditional authorization generator 124, a deterministic risk module 125, a transaction database 127, and an authorization retry module 128. Further details regarding the structure of an exemplary gateway computer 120 can be found in FIG. 2 and the corresponding description below.

The authorizing entity computer 130 may be an issuer or payment processing entity that can validate a user and/or ensure the availability of funds in order to authorize the transaction. The authorizing entity computer 130 may be a server computer comprising a processor and a computer readable medium coupled to the processor. The computer readable medium may comprise code, executable by the processor to implement any of the functions described herein by the authorizing entity computer 130.

Each of the components in the system in FIG. 1 can be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

FIG. 2 illustrates a block diagram of a gateway computer 200 according to embodiments of the invention. The gateway computer 200 may include a processor 202 and a network interface 210 for receiving and transmitting transaction authorization messages with a resource provider computer and an authorizing entity computer.

The gateway computer 200 may also include a non-transitory computer readable medium, wherein the non-transitory computer readable medium comprises a payment processing module 204A, a deterministic risk module 204B, a conditional authorization generator module 204C, and an authorization retry module 204D. The payment processing module 204A may coordinate, in conjunction with the processor 202, the sending of authorization request messages to a correct authorizing entity computer. In some embodiments, particularly for transactions with smaller banks, the payment processing module 204A may send the authorization request messages to a processor communication module (not shown in FIG. 2), wherein the processor 202 communication module can act as an intermediary to connect with the correct authorizing entity computer. The deterministic risk module 204B may, in conjunction with the processor 202, determine a conditional authorization response based upon a risk score. In some embodiments, the deterministic risk module 204B may also utilize one or more resource provider rules to determine the conditional authorization response. The conditional authorization generator module 204C may, in conjunction with the processor 202 and in response to the deterministic risk module 204B, generate a conditional authorization response. Lastly, the authorization retry module 204D may coordinate, in conjunction with the processor 202, the resending of eligible authorization request messages to the authorizing entity computer in order to obtain a final authorization response.

In some embodiments, the gateway computer 200 comprises a non-transitory computer readable medium, the non-transitory computer readable medium comprising code, executable by the processor 202, for implementing a method comprising: receiving an authorization request message from a resource provider computer; sending the authorization request message to an authorizing entity computer; receiving an error response from the authorizing entity computer; determining a conditional authorization response; sending the conditional authorization response to the resource provider computer; and sending a final authorization response to the resource provider computer.

The gateway computer 200 may further include a retry store 206. The retry store 206 comprises of authorization data for transactions that may require the resending of an authorization request message. The retry store 206 may, for example, store data for a number of transactions along with the time and date any retries, the number of any retries, and an identification of the authorizing entity computers for which authorization request messages were sent. Each transaction entry may also include data relating to the particular transaction including a transaction ID, a transaction amount, a resource provider identifier, etc. In some embodiments, the authorization data for a particular transaction may be removed from the retry store 206 after completion of the transaction.

The gateway computer 200 may further include a transaction database 208. The transaction database 208 includes a registry of transactions that have been assigned a conditional authorization response. In some embodiments, the transaction database 208 may, in response to a final authorization response, update a registered transaction to indicate that the final authorization response has been received and the registered transaction has been completed. The data in the transaction database 208 may be tied to the data in the retry store 206. In some embodiments, the retry store 206 and the transaction database 208 may be present in a single database.

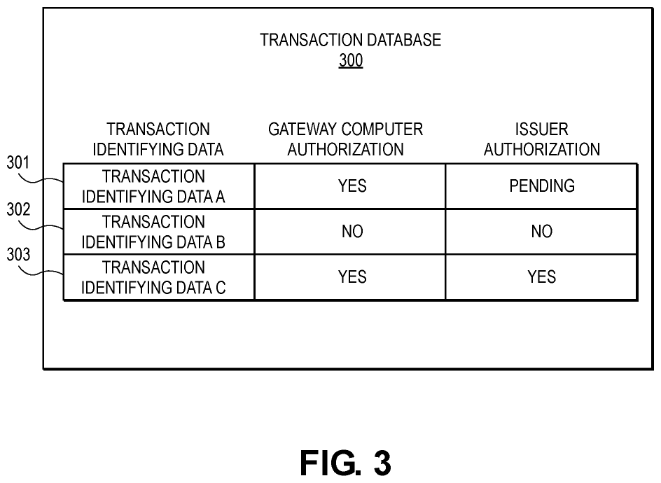

FIG. 3 shows schematic diagram of a transaction database 300 according to embodiments of the invention.

The transaction database 300 may comprise a table, wherein the results of a gateway computer authorization (e.g., the generation of a conditional authorization response) and issuer authorization (e.g., the generation of a final authorization response) are listed for each transaction entry 301-303. A transaction entry 301-303 may also include transaction identifying data (e.g., a transaction ID, a transaction amount, a resource provider identifier, an authorizing entity identifier, etc.). In some embodiments, a transaction entry may contain at least all of the original authorization request data. The result of a gateway computer authorization may indicate the generation of a conditional authorization response, determined by a deterministic risk module and one or more resource provider rules, such that the determination is based at least on a probability that a transaction will be fulfilled. The result of an issuer authorization may indicate the generation of either a normal authorization response message (e.g., an authorization response message that is processed normally, without any preceding conditional authorization response message), or a final authorization response message. For example, with reference to FIG. 3, the transaction database 300 may include an entry 301 for a transaction with transaction identifying data A, an indication that a resource provider computer has received a conditional authorization response from a gateway computer for the transaction, and an indication that a final authorization response message has still not been received. In this example, the entry 301 indicates a positive gateway computer authorization and an incomplete issuer authorization for the transaction. Upon receiving a final authorization response, the issuer authorization entry for the transaction will be updated appropriately to indicate whether the transaction is authorized or not by an authorizing entity computer (e.g., an issuer).

As another example, the transaction database 300 may include a transaction entry 302 with transaction identifying data B for a transaction, an indication that a resource provider computer has not received either a normal authorization response message from an authorizing entity computer or a conditional authorization response from a gateway computer. In yet another example, the transaction database 300 may also include a transaction entry 303 for a transaction with transaction identifying data C, an indication that a conditional authorization response from a gateway computer has been received, and an indication that a final authorization response message has also been received.

A method can be described with reference to FIGS. 1-3. In the method, a user may wish to use a user device 101 to conduct a transaction with a resource provider operating a resource provider computer 110 to obtain a resource (e.g., a good or a service) from the resource provider. In some embodiments, the resource provider computer 110 may be operated by a resource provider, such as a merchant, and the transaction may be an e-commerce purchase for a product that will be later shipped to the user of the user device 101.

In step S1, a user operating the user device 101 may initiate the transaction with the resource provider computer 110. For example, the user device 101 may initiate the transaction via a website of the resource provider that is hosted on the resource provider computer 110. The user may also enter information such as a primary account number, shipping information, and billing information into the user device 101 for submission to the resource provider computer 110.

In step S2, the resource provider computer 110 may generate and send an authorization request message to the gateway computer 120 to request authorization of the transaction. The authorization request message may include data such as a transaction value, a resource provider identifier, a timestamp, a payment method, etc. The authorization request message may be processed by the payment processing module 121 of the gateway computer 120.

In step S3, the payment processing module 121 may pass the authorization request message to a processor communication module 122 of the gateway computer 120.

In step S4, the processor communication module 122 may attempt to connect to an authorizing entity computer 130 and send the authorization request message to the authorizing entity computer 130. In step S4, the payment communication module 122 may fail to communicate with the authorizing entity computer 130 and/or receive an error response from the authorizing entity computer 130, or a node that resides between the authorizing entity computer 130 and the gateway computer 120. For example, the processor communication module 122 may encounter a connection failure because the authorizing entity computer 130 is temporarily offline. The processor communication module 122 may also initialize a timer when it attempts to connect to the authorizing entity computer 130 at periodic time intervals. If the processor communication module 122 does not receive a response within a set period of time (e.g., 5 minutes) the connection may time out.

In step S5, the processor communication module 122 may write the authorization request data to a retry store 123 of the gateway computer 120. The retry store 123 can provide information that will cause the processor communication module 122 to retry sending the authorization request message to the authorizing entity computer 130 at a later time. The retry store 123 may be, for example, a database or queue, such as MQ or RabbitMQ, or a streaming data service, such as Kafka. The processor communication module 122 may also send a response S6a to the payment processing module 121, indicating whether or not the processor communication module 122 was able to connect to the authorizing entity computer 130.

In step S6b, the payment processing module 121 may invoke the conditional authorization generator 124, if the response S6a from the processor communication module 122 indicates that it was not able to connect to the authorizing entity computer 130. The payment processing module 121 may send the authorization request data to the conditional authorization generator 124.

In step S7, the conditional authorization generator 124 may send the authorization request data to a deterministic risk module 125. The deterministic risk module 125 may then generate a risk score for the authorization request message. For example, the risk score may be a probability that the transaction will have completed successfully if the processor communication module 122 had connected to the authorizing entity computer 130. The risk score may be based on a variety of risk factors. The risk factors may include whether the user device 101 has previously interacted with the resource provider, the transaction velocity of the particular account number being used to conduct the transaction, the type of resource provider, the types of resources (e.g., goods) to be obtained, etc. Risk factors may also include the time of the transaction, the identity of the resource provider, and the transaction value.

In step S8, the conditional authorization generator 124 may analyze the authorization request using one or resource provider rules 126. The resource provider rules 126 may be predetermined by the resource provider computer 110 to control preferences for the generation of conditional authorizations. Resource provider rules 126 may be the same or different than rules used by the deterministic risk module 125.

In some embodiments, the use of one or more resource provider rules may be based on the risk score generated by the deterministic risk module 125. For example, the resource provider computer 110 may only want transactions with a risk score greater than a predetermined threshold value (e.g., 90 out of 100) (e.g., as determined by the deterministic risk module 125) to be considered for conditional authorization. In some embodiments, a subset of risk rules could then be selected based upon the risk score. For example, one or more resource provider rules 126 may be based on the transaction value and may be selected in response to receiving the risk score. For example, the resource provider computer 110 may only want transactions with a value less than another predetermined threshold (e.g., $50) to be considered for conditional authorization. Alternatively, or additionally, one or more resource provider rules 126 may be based upon the time of the transaction or other factors. For example, the resource provider computer 110 may set a limit of 100 conditional authorizations per day, or may not allow conditional authorizations for transactions conducted between midnight and 4 A.M. One or more resource provider rules 126 may also be based on the payment device (e.g., a credit card or a prepaid card) used for the transaction. For example, a resource provider computer 110 may only want transactions completed with a credit card to be considered for conditional authorization, or may only allow up to 3 conditional authorizations per day for any credit card. Resource provider rules 126 may be based on any combination of these and other factors. In some embodiments of the invention, the resource provider rules 126 may be included within the deterministic risk module 125.

Based on a combination of the risk score and resource provider rules, the conditional authorization generator 124 may generate a conditional authorization response. For example, the deterministic risk module 125 may determine that the risk score is sufficiently acceptable to generate a conditional authorization, but the transaction may violate a resource provider rule 126, and thus the conditional authorization generator 124 may not generate a conditional authorization response. In another example, the deterministic risk module 125 may indicate that the risk score is too high to generate a conditional authorization, even if the transaction passes all of the resource provider rules. In step S9, the conditional authorization generator 124 may then store the conditional authorization response in a transaction database 127, along with any other suitable data (e.g., the data used to determine the conditional authorization response, risk scores, transaction data, etc.).

In step S10, the conditional authorization generator 124 may send the conditional authorization response to the resource provider computer 110. The resource provider computer 110 may then be able to continue with the transaction process. The resource provider computer 110 may transmit a message to the user device 101 indicating that the transaction is authorized, or that the transaction is conditionally authorized. The resource provider computer 110 may also be able to begin fulfillment, for example, in the case of purchasing goods that will be shipped to the user of the user device 101. However, the received conditional authorization response does not guarantee the completion of the transaction as the user of the user device 101 may still default on or be unable to fulfill a payment for the transaction. Therefore, a final authorization response may be required before the resource provider computer 110 finishes fulfillment of the transaction (e.g., capturing transaction funds from the user device 101 and shipping the goods to a location(s) determined by the user of user device 101).

In step S11a, an authorization retry module 128 may read authorization request data corresponding to the transaction from the retry store 123. The authorization retry module 128 may then use the authorization request data to generate a new authorization request message.

In step S11b, the authorization retry module 128 may compare the authorization request data to the conditional authorization response data in the transaction database 127. The authorization retry module 128 may determine that authorization requests should be retried based on the conditional authorization responses. For example, some requests in the retry store 123 may not be associated with conditional authorization responses, because the risk score and/or the resource provider rules may have prevented a conditional authorization response from being created. Thus, authorization requests with an associated conditional authorization response may be characterized as retriable authorization requests.

In step S12, the authorization retry module 128 can retry sending another authorization request message to the processor communication module 122. The authorization request message may be generated using the authorization request data stored within the transaction database 127.

In step S13, the processor communication module 122 may try again to send the authorization request message, comprising the original authorization request data, to the authorizing entity computer 130.

Steps S12 and S13 may be executed multiple times until either a final authorization response (either approval or decline) is received (as in step S20) or a retry threshold is exceeded. The retry threshold may set the number of times an authorization request message can be retried until the authorization is abandoned. The retry threshold may be part of a service level agreement, and may be defined by the gateway computer 120 and/or resource provider rules 126. For example, a resource provider computer 110 may only want an authorization to be retried three times before cancelling the transaction. In some embodiments, the resource provider rules 126 may also define a set period of time, wherein the final authorization response must be received within the set period of time. For example, a resource provider computer 110 may only want to wait 3-7 days to receive a final authorization response. If a final authorization response is not received within this set period of time, the transaction may be cancelled.

In step S14, the authorization retry module 128 may write the final authorization response as received from the authorizing entity computer 130 to the transaction database 127. The authorization retry module 128 may then remove the data associated with the final authorization request from the retry store 123. In the event that the gateway computer 120 cannot reach the authorizing entity computer 130, or if the authorizing entity computer 130 declines the authorization request, the gateway computer 120 may transmit a negative final authorization response with a decline indicator to the resource provider computer 110. In some embodiments, the gateway computer 120 may also reverse the conditional authorization previously sent to the resource provider computer 110 if the gateway computer 120 cannot reach the authorizing entity computer 130, or if the authorizing entity computer 130 declines the authorization request.

In step S15, the resource provider computer 110 may receive the final authorization response message. In some embodiments, the authorization retry module 128 may return the final authorization response to the resource provider computer 110. In other embodiments, the final authorization response may be returned to the resource provider computer 110 by the payment processing module 121. In some embodiments, the resource provider computer 110 may also periodically poll the gateway computer 120 for the final determination of a previously obtained conditional authorization response, for example, via a web service call or a batch API. In some embodiments, the resource provider computer 110 may also have a webhook or alternate call back mechanism in place for the gateway computer 120 to return the final authorization response.

Once the resource provider computer 110 has received the final authorization response message, the resource provider may provide access to the resource (e.g., ship the goods) in the case of a positive final authorization response or deny access to the resource (e.g., stop the shipment and cancel the transaction) in the case of a negative final authorization response. The resource provider computer 310 may then make a capture call of all transactions with a positive final authorization response. The resource provider computer 110 may then send the capture call to the gateway computer 120 to get the funds for the transactions.

In some embodiments the conditional authorization generator 124 may have an analysis module. The conditional authorization generator 124 may use the analysis module to score the generated conditional authorizations with the final authorizations received from the authorizing entity computer 130. The scoring may be based on statistical odds of how often a final authorization will be received if a conditional authorization was generated. For example, the analysis module may determine that 60% of the conditional authorizations generated for transactions between 3 and 4 AM resulted in declined final authorizations. The analysis module may then adjust the deterministic risk module 125 to assign a higher risk to transactions made in that time period. Over time, these adjustments may allow the conditional authorization generator 124 to better predict when successful final authorization responses occur.

At the end of the day or at any other suitable time, a clearing and settlement process can occur between the authorizing entity computer 130 and an acquirer computer of an acquirer associated with the resource provider computer 110 to clear and settle the amount approved for the transaction in the final authorization response message.

Embodiments of the invention provide a number of advantages. For example, a conditional authorization process according to embodiments can allow a transaction to continue even if technical failures or other errors prevent completion of a traditional transaction flow. Further, because a user device does not receive an indication of a negative authorization response message from an authorizing entity computer if there are technical failures or other network issues, the user of the user device 101 does not have to re-submit his credentials to the resource provider computer 110. This saves time and also reduces the number of communications that might be otherwise needed to complete a transaction. This also improves data security, since the re-submission of the user's credentials increases exposure of those credentials to theft. Further, in embodiments, the original authorizing entity computer can maintain control over the final authorization of the transaction. While a resource provider may implement the conditional authorization in embodiments, implementing conditional authorization at the resource provider level may subject the resource provider to Payment Card Industry (PCI) Security Standards compliance as the resource provider would need to store payment request data. However, implementing conditional authorization with a gateway computer 120 in other embodiments may obviate the burden of PCI Security Standards compliance from resource providers.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a gateway computer, an authorization request message for a transaction from a resource provider computer;
sending, by the gateway computer, the authorization request message to an authorizing entity computer;
receiving, by the gateway computer, an error response from the authorizing entity computer;
determining, by the gateway computer, a conditional authorization response;
sending, by the gateway computer, the conditional authorization response to the resource provider computer; and
sending, by the gateway computer, a final authorization response to the resource provider computer.

2. The method of claim 1, further comprising:
storing data associated with the authorization request message in a retry store;
associating the authorization request message with the conditional authorization response;
periodically resending the authorization request message to the authorizing entity computer; and
receiving the final authorization response from the authorizing entity computer.

3. The method of claim 1, wherein determining the conditional authorization response comprises:
analyzing a risk score for the authorization request message;
evaluating one or more rules determined by the resource provider computer; and
determining a conditional authorization response based on the risk score and the one or more rules.

4. The method of claim 3, wherein the risk score is calculated based on past transaction history with a resource provider, a time of the transaction, and a transaction value.

5. The method of claim 3, wherein the one or more rules determined by the resource provider computer includes a rule that denies conditional authorization for a transaction having a risk score greater than a predetermined threshold value.

6. The method of claim 3, wherein the one or more rules determined by the resource provider computer includes a rule that denies conditional authorization for a transaction having an amount greater than a predetermined amount.

7. The method of claim 1, wherein the authorization request message includes a transaction value, a resource provider identifier, a timestamp, and a payment method.

8. The method of claim 1, wherein the error response is generated in response a failure to receive the final authorization response message within a predetermined time after sending the authorization request message.

9. A gateway computer comprising:
a processor; and
a non-transitory computer readable medium, the non-transitory computer readable medium comprising code, executable by the processor, for implementing a method comprising:
receiving an authorization request message for a transaction from a resource provider computer;
sending the authorization request message to an authorizing entity computer;
receiving an error response from the authorizing entity computer;
determining a conditional authorization response;
sending the conditional authorization response to the resource provider computer; and
sending a final authorization response to the resource provider computer.

10. The gateway computer of claim 9, wherein the resource provider computer is an access device.

11. The gateway computer of claim 9, wherein authorization request data associated with the error response is stored within a retry store at the gateway computer.

12. The gateway computer of claim 11, wherein the method further comprises
generating and transmitting one or more retriable authorization request messages using the authorization request data stored within the retry store.

13. The gateway computer of claim 12, wherein the final authorization response is determined in response to the generating and transmitting the one or more retriable authorization request messages.

14. The gateway computer of claim 13, wherein the final authorization response is an ISO 8583 message.

15. The gateway computer of claim 13, wherein the final authorization response message is an ISO 8583 message.

16. The gateway computer of claim 9, wherein in the transaction, the resource provider computer cancels the transaction, in response to a negative final authorization response.

17. The gateway computer of claim 9, wherein data associated with the conditional authorization response is stored within a transaction database in the gateway computer.

18. The gateway computer of claim 17, wherein, in the method, in response to the final authorization response, the transaction database is updated with an entry with the stored data associated with the conditional authorization response with data associated with the final authorization response.

19. A method comprising:
sending, by a resource provider computer, an authorization request message to a gateway computer, wherein the gateway computer sends the authorization request message to an authorizing entity, receives an error response from the authorizing entity, and determines a conditional authorization response;
receiving, by the resource provider computer, the conditional authorization response from the gateway computer; and
receiving, by the resource provider computer, a final authorization response from the gateway computer.

20. The method of claim 19, wherein the final authorization response is determined in response to resending one or more retriable authorization request messages to the authorizing entity.
